(19) United States
(12) Patent Application Publication
(10) Pub. No.: US 2005/0107910 A1
(43) Pub. Date: May 19, 2005

(54) System and method of filling containers

(76) Inventors: Bruce H. Hanson, Endicott, NY (US); Michael A. Wisniewski, Owego, NY (US)

Correspondence Address: GREENBLUM & BERNSTEIN, P.L.C., 1950 ROLAND CLARKE PLACE, RESTON, VA, 20191, US

(21) Appl. No.: 10/715,516

(22) Filed: Nov. 19, 2003

(51) Int. Cl. G06F 7/00

(52) U.S. Cl. 700/223

(57) ABSTRACT

A system and method for filling containers is provided. The method includes assigning variables associated with at least one container and a number of drop points and determining at least one threshold value based on the variables. The product are then distributed within the at least one container for each drop point based on the determined at least one threshold value. The system includes a mechanism for accomplishing the method steps.

### BACKGROUND OF THE INVENTION

1. Field of the Invention

The invention generally relates to a system and method of filling containers and, more particularly, to a system and method of filling a plurality of containers for reducing a required amount of such containers in a system.

2. Background Description

The sorting of mail is a very complex, time consuming task. In general, the sorting of mail is processed though many stages, including back end processes, which sort or sequence the mail in delivery order sequence. These processes can either be manual or automated, depending on the mail sorting facility, the type of mail to be sorted such as packages, flats, letter and the like. A host of other factors may also contribute to the automation of the mail sorting, from budgetary concerns to modernization initiatives to access to appropriate technologies to a host of other factors.

In general, however, most modern facilities have taken major steps toward automation by the implementation of a number of technologies. These technologies include, amongst others, letter sorters, parcel sorters, advanced tray conveyors, flat sorters and the like. As a result of these developments, postal facilities have become quite automated over the years, considerably reducing overhead costs.

In one implementation, an automated sorting and sequencing machine may be used to sort and sequence the mail pieces. In this process, the machine transports pieces of mail to a drop point in a sequenced manner. At the drop point, the mail pieces are placed in containers for future delivery. In this type of system one parameter is typically used to ensure that the containers are not filled beyond their maximum fill depth: thickness of the mail pieces or the number of mail pieces for each container. As an example, certain known systems will never exceed six inches of fill depth per container to a maximum of 65 mail pieces per container. It is also well known that these containers have a depth of about eight inches, such that the maximum fill depth is substantially less than the actual depth of the container, itself. The difference or delta (Δ) provides a factor of safety, in operation, thus ensuring, in these known systems, that the mail pieces will not extend beyond a top plane of the container.

To measure the thickness of each mail piece, an encoder may be used in conjunction with a sorting and sequencing machine or device. The encoder is usually a moveable lever which, when moved by a passing mail piece, can determine the thickness of the mail piece. The use of encoders is well known to one of skill in the art. Also, photodiodes can be used to determine the number of mail pieces running through the system, in known processes. In either implementation, the gathered information is loaded to a computer, for example, and subsequently used when filling containers at each drop point. For example, the number of mail pieces or the thickness of the mail pieces are used to ensure that the containers are not filled beyond a maximum capacity, e.g., not greater than six inches of fill depth per container or a maximum of 65 mail pieces per container.

In implementation, though, the encoder usually measures only a portion of the mail pieces and more particularly about a one inch portion of the mail piece passing through the system. In many instances, however, this may not provide an accurate measurement since the mail piece may be thicker at another portion, e.g., the unmeasured portion of the mail piece. For this reason, the second parameter, the mail piece count, is used to ensure that a container is never overfilled; that is, not filled beyond a maximum of 65 mail pieces. Of course, other fill depths and mail piece count can be used, but the underlying concept, e.g., a maximum fill depth or never to exceed a maximum mail piece count, is always utilized by known systems. Thus, there can only be a maximum number of mail pieces, e.g., 65 mail pieces, per container, regardless of the thickness of each mail piece.

In these known systems, the thickness measurement or piece count alone is used to ensure that the containers are not filled beyond a predetermined maximum fill depth value. These systems cannot, though, ensure that the containers are utilized to their maximum capacity or are filled evenly or uniformly for each drop point. For example, in an exemplary illustration, 65 mail pieces may be provided in container “A₁” at drop point “A”, but these mail pieces are only a total of three inches in total thickness. In this scenario, the next mail piece for the particular drop point “A” would automatically be placed into another container “A₂”. This, of course, would leave approximately three inches of unused space (based on a 6 inch fill) in the container Al, thereby not efficiently using this container to its maximum capacity.

In another example, in a system with 360 drop points, there would be the need for several containers at each drop point. As can be imagined, this can lead to thousands of containers. Prior to each drop point, the mail pieces would be measured or counted in order to ensure that each container is not filled beyond its maximum fill value. However, at the end of the run, there is typically only several mail pieces left for each drop point. But, the amount of mail pieces remaining is not sufficient to completely fill each of the remaining containers at each of the drop points. Thus, these last containers, which could amount to 360 containers, a significant number, are underutilized. Also, since some or a majority of containers are not utilized to their maximum fill depth, as discussed in the above scenario, many additional containers may be needed for each sequencing event. This, in essence, increases the total amount of containers actually needed for each drop point.

Also, due to an effective increase in the amount of containers required, overhead costs are increased. These costs are not only associated with the additional containers, but are also due to additional labor required for moving, sorting and storage of the additional containers. Additionally, it is known in these systems that the containers are unevenly filled which may lead to, for example, uneven stacking of the containers during transportation and the like.

The invention is directed to overcoming one or more of the problems as set forth above.

### SUMMARY OF THE INVENTION

In a first aspect of the invention, a method is provided for filling containers with product. The method includes assigning variables associated with at least one container and a number of drop points and determining at least one threshold value based on the variables. The product are then distributed within the at least one container for each drop point based on the determined at least one threshold value.

In embodiments of the invention, if one threshold value is exceeded, the product amount is decremented. If the one threshold value is not exceeded, then a determination is made as to whether another container is required. Additionally, in embodiments, if the one threshold value is not exceeded, the method may substantially uniformly distribute the product throughout all of the containers within a particular drop point by averaging the product over the drop point for each container fill. The method further, in embodiments, determines (i) a best estimate of a number of containers needed if a level of fill varies between a maximum and minimum fill value of the at least one container and (ii) a best estimate of a number of containers needed if the number of product varies for the drop point. The product may be distributed based on a built fill table defining an amount of product to be placed in the at least one container.

In another aspect of the invention, a method is provided for distributing product at a drop point. The method includes calculating a best estimate of containers needed if a level of fill varies between a maximum fill value and a minimum fill value and a number of product varies. The method further calculates an expected number of containers needed for a drop point based on the calculated best estimate. A number of product required per container for the drop point is determined based on the number of product and the expected number of containers for the drop point. A determination is made whether a fill depth is less than or equal to the maximum fill value of the container. If the determination is positive, a container fill table is created having a drop point designation, and an associated number of containers and product to fill the containers. The containers, in embodiments, are filled based on the container fill table parameters.

In yet another aspect of the invention, a method includes retrieving thickness data and count data on pieces to be placed in containers and computing a number of containers required for the pieces based on an average of minimum and maximum fill capacities based on fill depth and fill count of the containers. The final container count is calculated by taking an average of the computing step.

A system and a computer program code are also provided by the invention.

### BRIEF DESCRIPTION OF THE DRAWINGS

FIG. 1 shows a general diagram of a sorting and sequencing device used with the invention;

FIG. 2 shows containers used with the invention;

FIG. 3 represents a flow diagram showing steps implementing the method of the invention; and

FIGS. 4a and 4b represent a flow diagram showing steps implementing the method of the invention.

### DETAILED DESCRIPTION OF EMBODIMENTS OF THE INVENTION

The invention is directed to a system and method of filling containers and, more particularly, to a system and method of filling a plurality of containers in the system such as, for example, a sorting and sequencing system. The invention reduces a required amount of such containers in a system by, for example, evenly or substantially uniformly distributing the product within the containers, or forcing additional product into a previous container. The system and method may be adapted for many types of applications and products such as, for example, mail pieces, flats, packages or other items (generally referred to as product) which are to be loaded in a container of any size, shape or dimension. Applications such as warehousing and storage applications are also contemplated for use with the invention.

In aspects of the invention, the products are sorted and sequenced via a sorting and sequencing machine, and after each pass, are dropped or placed, in some manner, into containers at drop points. The system and method of the invention ensures that the containers are uniformly filled and that all containers used in the system are utilized to their maximum capacity. In the method and system of the invention, the amount of containers required are thus reduced, which reduces overhead costs, including for example, labor, storage and material costs.

### System and Method of the Invention

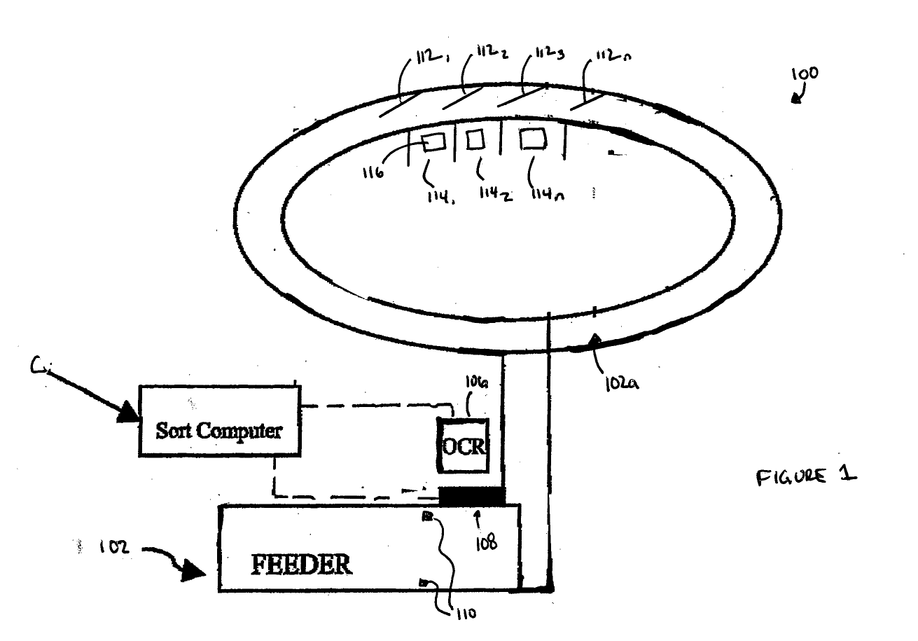

Referring now to FIG. 1, a schematic diagram of the sorting and sequencing device is shown. In the embodiment of FIG. 1, the sorting and sequencing device is generally depicted as reference numeral 100 and includes at least one feeder 102. In embodiments, the feeder 102 is a letter feeder with a feed rate capacity of approximately 40,000 letters per hour; however, the feeder 102 may equally be a flat feeder with a feed rate capacity of approximately 10,000 flats per hour or other type of feeder. Those of ordinary skill in the art should recognize, though, that other types of feeders, feeding capacity rates and the like may also be used with the invention, and that the feeder 102 shown in FIG. 1 is provided for illustrative purposes in describing the invention. It should further be recognized that more than one feeder may be used with the invention.

Referring still to FIG. 1, a conveying track 102a is associated with the feeder 102. The conveying track 102a may be belt transports, pocket/cartridge transports or any other well known conveying or transporting system for transporting the product to a destination bin or drop point, as discussed below.

A camera, optical reading device or other type of reading device 106 is provided downstream of the feeder 102. In embodiments, the camera or other reading type device 106 may be mounted to the conveying track 102a, but may be located near or proximate to the conveying track 102a or the feeder 102, itself. The camera or reading device 106 is designed to read the delivery point or other pertinent product information provided on each product in order to properly sort and sequence the product, as is well known in the art. For example, the sorting and sequencing of the product may use a well known two pass algorithm, which is easily implemented by one of ordinary skill in the art.

In embodiments, an encoder 108 is used to measure the thickness of each of the product as it passes through the system. Additionally, sensors 110 such as photodiodes may be used to count the number of product passing through the system. The encoders and photodiodes work in a well known manner. By example, the photodiode will count each product, as the product interrupts a light beam or the like. The encoder 110 may measure the thickness of each of the product by movement of a lever or the like, as is known in the art.

Still referring to FIG. 1, diverters 121₁₋ₙ, may be placed between sections of the conveying track 102a and respective destination bins or drop points 114₁₋ₙ. The diverters 112 are used to divert the respective product into the respective drop point 114. At each of the drop points is a container 116, used to contain or hold the product in a sequenced order, after final or other pass of the system. In one implementation, the product is transported from the conveying track to the destination bin via a ramp (not shown) or other known mechanism.

A control “C” (e.g., sort computer) controls and coordinates the systems of the machine of FIG. 1, in addition to providing, for example, the method of distributing the product throughout each of the containers 116 (as discussed in more detail below). For example, the controller may control the diverters depending on information received from the OCR, for example, in order to place the product in a desired container. The controller may also include memory for storing product information such as, for example, address information, thickness of product (as determined by the encoder) and number of pieces passing through the system (as counted by the photodiodes). The controlling of the diverters and the sorting and sequencing of product is well known in the art and is not discussed herein.

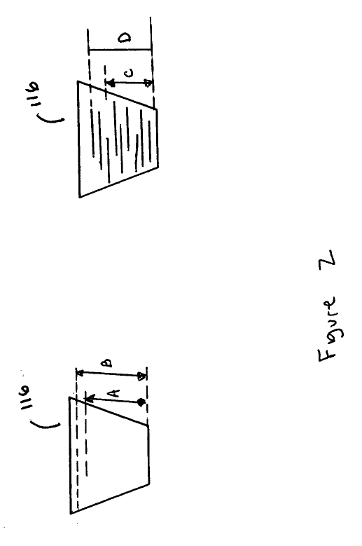

FIG. 2 shows containers 116 which may be used with the invention. It should be recognized that the fill capacity of the containers may be either in the horizontal orientation, as shown, and equally in a vertical orientation. Thus, in implementation, the container may be filled in either the horizontal or vertical orientation. In FIG. 2, a minimum and maximum fill value in inches is shown, as well as a minimum and maximum average number of product in a container. It should be understood that other dimensions such as represented by the metric system may also be used with the invention. By way of more detail:
A=Minimum fill value in inches where the container would be considered full.
B=Maximum fill value in inches or maximum capacity of the container.
C=Minimum number of pieces in the container to be considered full.
D=Maximum number of average pieces the container can hold.
   In an illustrative example, used hereafter, the implementation will be used for mail pieces; however, any product can be used with the invention. In the many examples provided, the following parameters will be used for illustration:
A=6″
B=8″
C=65 pieces
D=80 pieces
W=1 (number of drop points)
   As should be understood, these above parameters are for illustration and other parameters can be utilized with the invention. For example, the number of drop points, in a known system, can be W=360.

### Method of Uniformly Filling Containers using the Invention

In the invention, placement of product within containers may be accomplished by determining threshold values associated with, for example, the container and amount of drop points required for the product. The invention may be used to reduce the total number of containers required in the system by, for illustration, averaging the product throughout all of the containers or forcing additional product into a previous container or containers. The variables used by the system and method of the invention may include, for example, the maximum and minimum number of pieces and fill load of the containers.

If the system and method determines that the threshold has been exceeded, the product can be substantially evenly distributed for all of the containers within a particular drop point by averaging the product over the entire drop point for the container fill. If the system and method determines that the threshold is not exceeded, then the system and method may “force” the additional product into a previous container in order to reduce the number of containers needed for the particular drop point. In other words, the system and method may determine a “Δ” between the minimum and maximum values to thus eliminate the need for additional containers.

For illustrative purposes and not to limit the invention in any manner, a single drop point will be used to describe an illustrative example of the method of the invention. Additionally, three examples will be used to fully illustrative examples of the method. These examples, as described below, are for illustrative purposes and are not, in any way, limiting features of the invention.

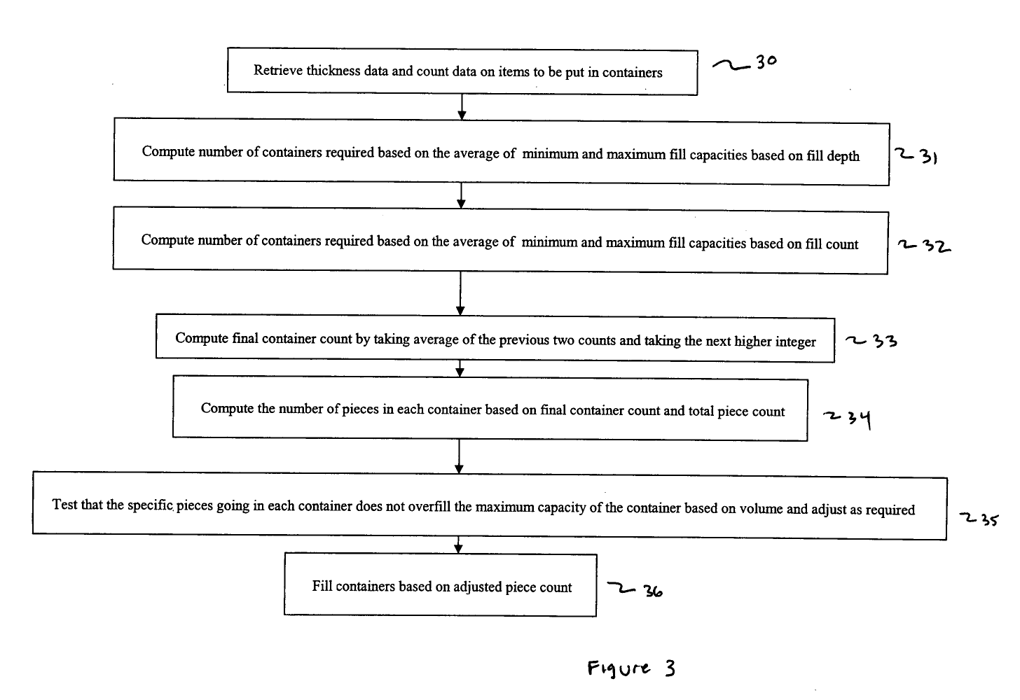

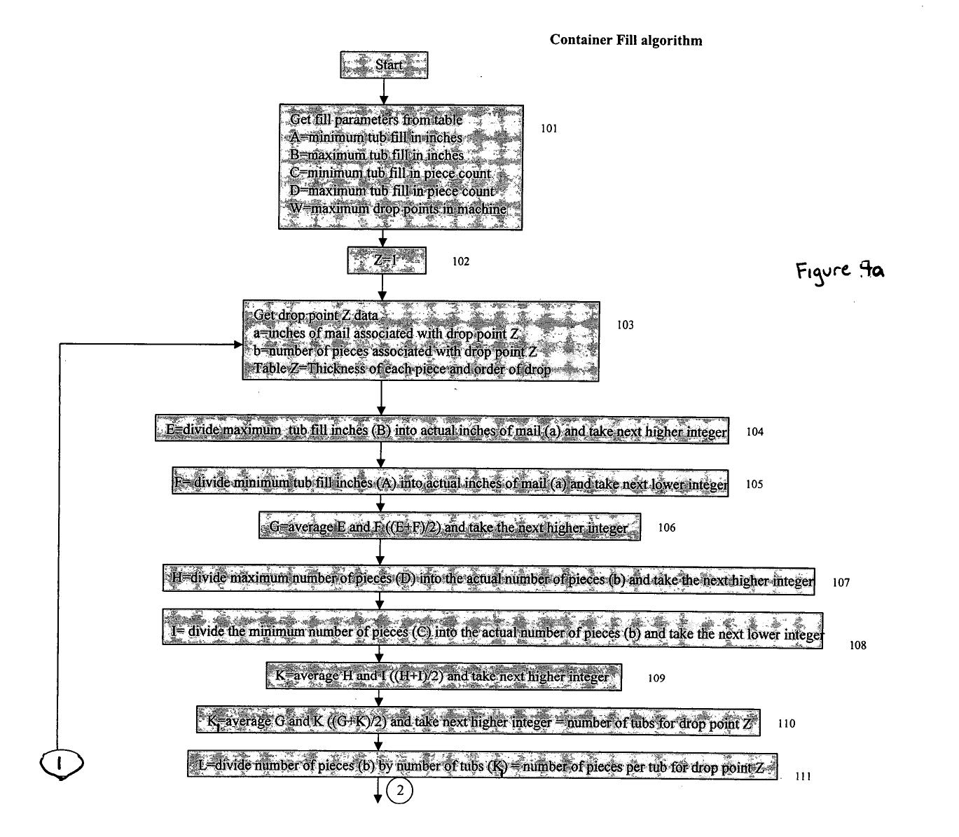

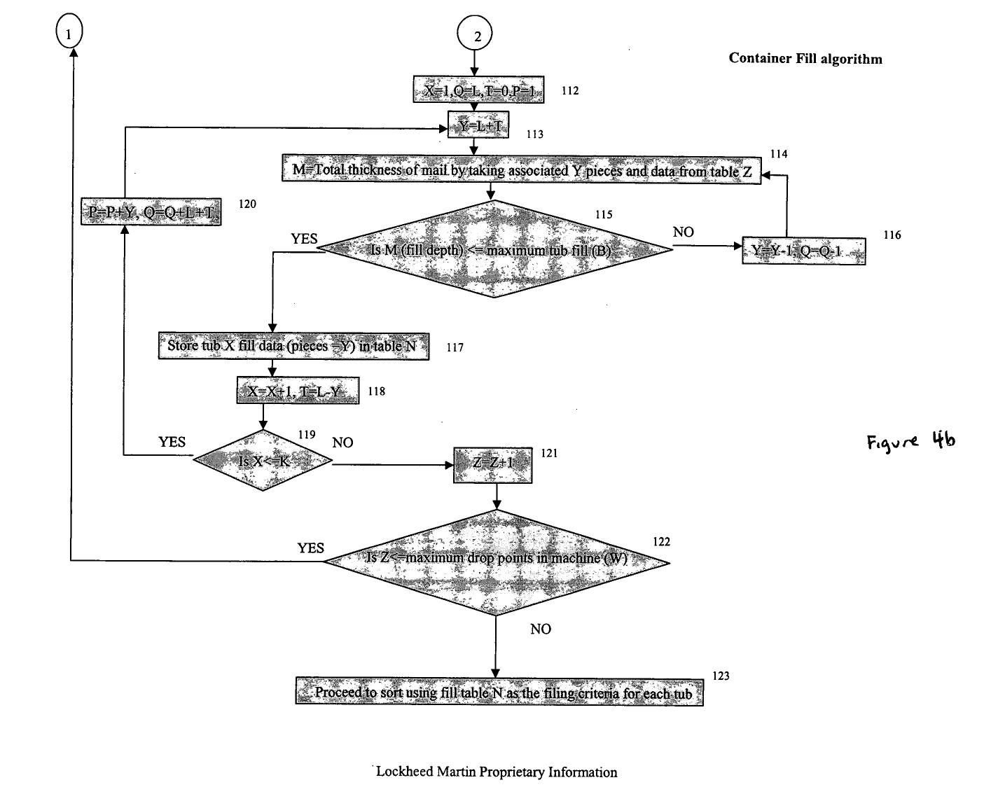

FIGS. 3, 4a and 4b represent a flow diagram showing the steps of implementing the method of the invention. The steps of the invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). FIGS. 3, 4a and 4b may equally represent a high level block diagram of the system of the invention, implementing the steps thereof.

Referring now to FIG. 3, a flow of the overall process is provided. In step 30, the process retrieves thickness data and count data on items to be put in the containers. In step 31, the number of containers required is computed based on the average of minimum and maximum fill capacities based on fill depth. In step 32, the number of containers required is computed based on the average of minimum and maximum fill capacities based on fill count. In step 33, the final container count is computed by taking average of the previous two counts and taking the next higher integer. In step 34, the number of pieces in each container is computed based on final container count and total piece count. In step 35, the process tests that the specific pieces going in each container does not overfill the maximum capacity of the container based on volume and adjusts, as required. In step 35, the containers are filled based on the adjusted piece count.

Referring now to FIGS. 4a and 4b, in step 101, the process assigns values A, B, C, D and W from a starting parameter table. As discussed above,
A=Minimum fill value (e.g., in inches) where the container would be considered full.
B=Maximum fill value in inches or maximum capacity of the container.
C=Minimum number of pieces in a container to be considered full.
D=Maximum number of average pieces a container can hold.
W=Maximum number of drop points.
   In step 102, the initial drop point identifier Z is initially set to 1. It should be understood that the drop point identifier will be incremented in future passes.

In step 103, the process sets the parameters a, b from drop point table pointed to by Z value. As now discussed,
a=total thickness (e.g., inches) of all pieces associated with drop point Z; and
b=total number of all pieces associated with drop point Z.
   In step 104, a new variable E is calculated. The variable E=a/B using the next higher integer. The variable E is representative of the number of containers if all of the containers are filled to the maximum fill value. In context, the next higher integer is defined as:
if fraction is 0→use integer
if fraction is >0→use integer +1
   Thus, in the example of 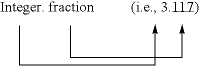
   the next higher integer would be 4.

In step 105, a new variable F is calculated. The variable F=a/A using the next lower integer. The variable F is representative of the number of containers if all of the containers are filled to the minimum fill value. In context, the next lower integer is defined as:
if fraction is 0→use integer −1
if fraction is >0→use integer
   Thus, in the example of 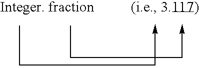
   the next lower integer would be 3.

In step 106, a new variable G is calculated. The variable G=(E+F)/2, using the next lower integer. The variable G is representative of the best estimate of a number of containers needed if the level of fill varies between a maximum and a minimum fill value. In step 107, another variable H is calculated. The variable H=b/D, using the next higher integer. The variable H is representative of the number of containers if all the containers are filled with the maximum number of product.

In step 108, a new variable I is calculated. The variable I=b/c, using the next lower integer. The variable I is representative of the number of containers if all of the containers are filled to the minimum number of product. In step 109, another variable K is calculated. The variable K=(H+I)/2, using the next higher integer. The variable K is a best estimate of number of containers needed if the number of product varies. In step 110, variable K₁ is calculated. The variable K₁=(G+K)/2, using the next higher integer. This variable is representative of the expected number of containers needed for a drop point.

In step 111, variable L is calculated. The variable L=b/K, using the next higher integer. The variable L is representative of the starting container fill number. In step 112, several variable are initialized. These variables include, for example,
X=1
Q=L
T=O
P=1
   In implementation, T is an incremental counter and P is a pointer starting at a beginning of a table, as discussed in more detail with reference to the examples provided below.

In step 113, the variable Y is set equal to L+T. That is, Y is the starting container fill number plus an incremental count. In step 114, a calculation is made for summing the thickness of each product from P to Q from the Z table. The Z table is a table for a particular drop point which identifies the total number of product for that drop point and the thickness of each of the product. Representatively, the step 114 can be mathematically shown as
M=Σ_{P}^{Q}pieces (#) thickness

In step 115, a determination is made as to whether the fill depth M is less than or equal to the maximum container fill (B) (i.e., M≦B). This step will provide a test that selected pieces fit within a maximum container fill constraint. If not, then at step 116, Y is decremented to Y−1 and Q is decremented to Q=Q−1. That is, the product counters are decremented by 1. The process then returns to step 114 and step 115.

In the case that the fill depth M is less than or equal to the maximum container fill value, the process proceeds to step 117. In step 117, the container fill data X (pieces=Y) is stored in a table N, for example. Table N may be represented as:

Container fill table

| Drop Z | Container # | Piece fill |
|---|---|---|
| Z | X | Y |

In step 118, the system is incremented by X=X+1 and T=L−Y. More specifically, in one aspect, the system is incremented for a new container X and the counters are set to look at next possible container associated with drop Z.

In step 119, a determination is made as to whether a next container is required. That is, if the container count is less than expected, e.g., X≦K₁, the process will continue at step 120. In step 120, the variables will be adjusted to look at a next window of items in the Z table. For example, P=P+Y and Q=Q+L+T. The process will then return to step 113.

In step 119, if X is not less than or equal to K₁, then the process continues to step 121. In step 121, Z is set for the next drop point, Z=Z+1. In step 122, a determination is made as to whether there are any further drop points, represented as Z≦W. If there are no further drop points, then the system exits at step 123 to follow on processing using the container fill table. If there are further drop points, then the process continues to step 103, to begin the process again.

In the illustrative examples below, the process and system will be explained with particular detail to specific examples. As discussed above, these examples are provided for only illustration and are not limiting features of the invention.

### EXAMPLE 1

In this example, the following variables will be used:
A=6″
B=8″
C=65 pieces
D=80 pieces
W=1 (number of drop points)

This example, will also utilize the following Z table having 70 pieces of product with various thicknesses totaling 10.18 inches. The thickness of the first 35 pieces of product total 8.15 inches.

TABLE Z

| | Piece # | Thickness | |
|---|---|---|---|
| | 1 | .05 | |
| | . | . | |
| | . | . | |
| | . | . | [symbol] Total Thickness sum |
| | | | Pieces 1-35 = 8.15″ |
| | 35 | .15 | |
| | . | . | |
| | . | . | |
| | . | . | |
| | 70 | | |
| Total | b = 70 | a = 10.18″ | |

Now following the steps of the flow of FIGS. 4a and 4b, using the above variables,

STEPS

| 101 | A = 6 B = 8 C = 65 D = 80 W = 1 | | |
|---|---|---|---|
| 102 | Z = 1 | | |
| 103 | a = 10.18″ b = 70 | | |
| 104 | E = 10.18/8 = 1.27 | | |
| | Next Higher = 2 | | |
| 105 | F = 10.18/6 = 1.69 | | |
| | Next Lower = 1 | | |
| 106 | G = (2 + 1)/2 = 1.5 | | |
| | Next Higher = 2 | | |
| 107 | H = 70/80 = .875 | | |
| | Next Higher = 1 | | |
| 108 | I = 70/65 = 1.07 | | |
| | Next Lower = 1 | | |
| 109 | K = (1 + 1)/2 = 1 | | |
| | Next Higher = 1 | | |
| 110 | K₁ = (2 + 1)/2 = 1.5 | | |
| | Next Higher = 2 | | |
| 111 | L = 70/2 = 35 | | |
| | Next Higher = 35 | | |
| 112 | X = 1 Q = 35 T = 0 P = 1 | | |
| 113 | Y = 35 + 0 = 35 | | |
| 114 | 35 | | |
| | M = Σ piece thickness = 8.15″ | | |
| | 1 | | |
| 115 | 8.15″ ≦ 8 → no | | |
| 116 | Y = 35 − 1 = 34 | | |
| | Q = 35 − 1 = 34 | | |
| 114 | 34 | | |
| | M = Σ piece thickness = 8″ | | |
| | 1 | | |
| 115 | 8 ≦ 8 → yes | | |
| 117 | Container fill table | | |
| | Drop Z | Container # | Pieces fill |
| | 1 | 1 | 34 |
| 118 | X = 1 + 1 = 2 | | |
| | T = 35 − 34 = 1 | | |
| 119 | 2 ≦ 2 → yes | | |
| 120 | P = 1 + 34 = 35 | | |
| | Q = 34 + 35 + 1 = 70 | | |
| 113 | Y = 35 + 1 = 36 | | |
| 114 | 78 | | |
| | M = Σ piece thickness = 2.18″ | | |
| | 35 | | |
| 115 | 2.18 ≦ 8 → yes | | |
| 117 | Container fill table | | |
| | Drop Z | Container # | Pieces fill |
| | 1 | 1 | 34 |
| | 1 | 2 | 36 |

| | |
|---|---|
| 118 | X = 2 + 1 = 3 |
| | T = 35 − 36 = −1 |
| 119 | 3 ≦ 2 → no |
| 121 | Z = 1 + 1 = 2 |
| 122 | 2 ≦ 1 → no |
| 123 | Exit |

### EXAMPLE 2

In this example, the following variables will be used:
A=6″
B=8″
C=65 pieces
D=80 pieces
W=1 (number of drop points)

This example, will also utilize the following Z table having 2 pieces of product with various thicknesses totaling 0.2 inches.

TABLE Z

| | Piece # | Thickness |
|---|---|---|
| | 1 | .05 |
| | 2 | .15 |
| Total | b = 2 | a = .2 |

Now following the steps of the flow of FIGS. 4a and 4b, using the above variables,

STEPS

| 101 | A = 6 B = 8 C = 65 D = 80 W = 1 | | |
|---|---|---|---|
| 102 | Z = 1 | | |
| 103 | a = .2″ b = 2 | | |
| 104 | E = .2/8 = .25 | | |
| | Next Higher = 1 | | |
| 105 | F = .2/6 = .033 | | |
| | Next Lower = 0 | | |
| 106 | G = (1 + 0)/2 = .5 | | |
| | Next Higher = 1 | | |
| 107 | H = 2/80 = .025 | | |
| | Next Higher = 1 | | |
| 108 | I = 2/65 = .03 | | |
| | Next Lower = 0 | | |
| 109 | K = (1 + 0)/2 = .5 | | |
| | Next Higher = 1 | | |
| 110 | K₁ = (1 + 1)/2 = 1 | | |
| | Next Higher = 1 | | |
| 111 | ′L = 2/1 = 2 | | |
| | Next Higher = 2 | | |
| 112 | X = 1 Q = 2 T = 0 P = 1 | | |
| 113 | Y = 2 + 0 = 2 | | |
| 114 | 2 | | |
| | M = Σ piece thickness = .2 | | |
| | 1 | | |
| 115 | .2″ ≦ 8 → yes | | |
| 117 | Container fill table | | |
| | Drop Z | Container # | Pieces fill |
| | 1 | 1 | 2 |

| | |
|---|---|
| 118 | X = 1 + 1 = 2 |
| | T = 2 − 2 = 0 |
| 119 | 2 ≦ 1 → no |
| 121 | Z = 1 + 1 = 2 |
| 122 | 2 ≦ 1 → no |
| 123 | Exit |

### EXAMPLE 3

In this example, the following variables will be used:
A=6″
B=8″
C=65 pieces
D=80 pieces
W=1 (number of drop points)

This example, will also utilize the following Z table having 12 pieces of product with each piece having a thickness of one inch for a total thickness of 12 inches.

TABLE Z

| | Piece # | Thickness |
|---|---|---|
| | 1 | 1 |
| | . | . |
| | . | . |
| | . | . |
| | 8 | 1 |
| | 9 | 1 |
| | . | . |
| | . | . |
| | . | . |
| | 12 | 1 |
| Total | b = 12 | a = 12 |

Now following the steps of the flow of FIG. 3, using the above variables,

STEPS

| 101 | A = 6 B = 8 C = 65 D = 80 W = 1 | | |
|---|---|---|---|
| 102 | Z = 1 | | |
| 103 | a = 12 b = 12 | | |
| 104 | E = 12/8 = 1.5 | | |
| | Next Higher = 2 | | |
| 105 | F = 12/6 = 2 | | |
| | Next Lower = 1 | | |
| 106 | G = (2 + 1)/2 = 1.5 | | |
| | Next Higher = 2 | | |
| 107 | H = 12/80 = .15 | | |
| | Next Higher = 1 | | |
| 108 | I = 12/65 = 18 | | |
| | Next Lower = 0 | | |
| 109 | K = (1 + 0)/2 = .5 | | |
| | Next Higher = 1 | | |
| 110 | K = (1 + 1)/2 = 1.5 | | |
| | Next Higher = 2 | | |
| 111 | L = 12/2 = 6 | | |
| | Next Higher = 6 | | |
| 112 | X = 1 Q = 6 T = 0 P = 1 | | |
| 113 | Y = 6 + 0 = 6 | | |
| 114 | 6 | | |
| | M = Σ piece thickness = 6 | | |
| | 1 | | |
| 115 | 6 ≦ 8 → yes | | |
| 117 | Container fill table | | |
| | Drop Z | Container # | Pieces fill |
| | 1 | 1 | 6 |
| 118 | X = 1 + 1 = 2 | | |
| | T = 6 − 6 = 0 | | |
| 119 | 2 ≦ 2 → yes | | |
| 120 | P = 1 + 6 = 7 | | |
| | Q = 6 + 6 + 0 = 12 | | |
| 113 | Y = 6 + 0 = 6 | | |
| 114 | 12 | | |
| | M = Σ piece thickness = 6 | | |
| | 7 | | |
| 115 | 6 ≦ 8 → yes | | |
| 117 | Container fill table | | |
| | Drop Z | Container # | Pieces fill |
| | 1 | 1 | 6 |
| | 1 | 2 | 6 |

| | |
|---|---|
| 118 | X = 2 + 1 = 3 |
| | T = 6 − 6 = 0 |
| 119 | 3 ≦ 2 → no |
| 121 | Z = 1 + 1 = 2 |
| 122 | 2 ≦ 1 → no |
| 123 | Exit |

In this manner, the examples provided above show that the containers be efficiently utilized for each drop point. In one implementation, the containers will be uniformly filled for each container throughout the drop point. In another implementation, the product or number of products will be forced into a previous container.

While the invention has been described in terms of embodiments, those skilled in the art will recognize that the invention can be practiced with modification within the spirit and scope of the appended claims.

1. A method of filling containers with product, comprising:
assigning variables associated with at least one container and a number of drop points;
determining at least one threshold value based on the variables; and
distributing the product within the at least one container for each drop point based on the determined at least one threshold value.

2. The method of claim 1, wherein the variables include at least one of:
A=Minimum fill value where the at least one container would be considered full;
B=Maximum fill value or maximum capacity of the at least one container;
C=Minimum number of product in the at least one container to be considered full;
D=Maximum number of average product the at least one container can hold; and
W=number of drop points.

3. The method of claim 1, wherein:
if one of the at least one threshold value is exceeded, the product amount is decremented;
if the one threshold value is not exceeded, then a determination is made as to whether another container is required.

4. The method of claim 1, wherein if one of the at least one threshold value is not exceeded, substantially uniformly distributing the product throughout all of the containers of the at least one container within a particular drop point by averaging the product over the drop point for each container fill.

5. The method of claim 4, further comprising:
setting a counter to look at a next possible container associated with the drop point and determining whether the next possible container is required, if the next container is not required, adjusting the variables to determine if any of the product can be forced into a previous container.

6. The method of claim 1, wherein the determining step includes:
determining at least one of:
a=total thickness of all product;
b=total number of all product;
Z=thickness of each product and an order of drop;
determining a best estimate of a number of containers needed if a level of fill varies between a maximum and minimum fill value of the at least one container; and
determining a best estimate of a number of containers needed if the number of product varies for the drop point.

7. The method of claim 6, wherein:
the determining a best estimate of the number of containers needed if the level of fill varies between the maximum and minimum fill value includes:
providing an average between (i) a number of containers if all of the containers of the at least one container are filled to the maximum fill value and (ii) the number of containers if all of the containers are filled to the minimum fill value; and
the determining a best estimate of the number of containers of the at least one container needed if the number of product varies for the drop point includes:
providing an average between (i) a number of containers of the at least one container if all of the containers are filled with the maximum number of product and (ii) the number of containers if all of the containers are filled to the minimum number of product.

8. The method of claim 7, further comprising providing a starting container fill number, the starting container fill number being the number of product associated with the drop point divided by a number of product for the drop point.

9. The method of claim 1, further comprising building a fill table defining an amount of product to be placed in the at least one container, the fill table being created by:
calculating a best estimate of containers needed if a level of fill varies between a maximum fill value and a minimum fill value and a number of product varies;
calculating an expected number of the containers needed for a drop point based on the calculated best estimate;
determining a number of product required per container for the drop point based on the number of product and the expected number of the containers for the drop point; and
determining whether a fill depth is less than or equal to the maximum fill value of the at least one container.

10. The method of claim 1, wherein the determining step further includes determining an expected number of containers of the at least one container required for the drop point.

11. The method of claim 1, wherein the determining step includes:
determining whether a fill depth of the at least one container is less than or equal to a maximum fill value of the container;
if so, determining whether the at least one container count is less than an expected fill count;
if not less, determining whether a total number of product and each thickness thereof for a particular drop point is less than or equal to the number of drop points; and
if so, then distributing the product into the at least one container for the drop point.

12. The method of claim 11, wherein when the at least one container count is less than or equal to an expected fill count, adjusting the variables to determine how many product must be removed from the at least one container.

13. The method of claim 1, wherein the product are mail pieces.

14. A method for distributing product at a drop point, comprising the steps of:
calculating a best estimate of containers needed if a level of fill varies between a maximum fill value and a minimum fill value and a number of product varies;
calculating an expected number of the containers needed for a drop point based on the calculated best estimate;
determining a number of product required per container for the drop point based on the number of product and the expected number of containers for the drop point;
determining whether a fill depth of the containers is less than or equal to the maximum fill value of the containers; and
if the determining step of fill depth is less than or equal to the maximum fill value, creating a container fill table having a drop point designation, and an associated number of containers and product to fill the containers.

15. The method of claim 14, further comprising providing values to calculate the best estimate and the expected number of containers, the values includes at least one of:
A=Minimum fill value where a container of the containers would be considered full;
B=Maximum fill value or maximum capacity of the container;
C=Minimum number of pieces in a container to be considered full;
D=Maximum number of average pieces the container can hold;
W=Maximum number of drop points;
a=total thickness of all product; and
b=total number of all product.

16. The method of claim 15, wherein:
the calculating a best estimate of containers needed if a level of fill varies between a maximum fill value and a minimum fill value includes:
(i) a/B and using a next higher integer;
(ii) a/A and using next lower integer; and
(iii) ((i)+(ii))/2; and
the calculating a best estimate of containers needed if a number of fill varies between the maximum fill value and a minimum fill value includes:
(a) b/D using a next higher integer;
(b) b/C and using a next lower integer; and
(c) ((a)+(b))/2.

17. The method of claim 15, further comprising determining whether a container count is less than or equal to the expected number of containers for the drop point and if so adjusting piece count of the product for the container.

18. The method of claim 15, further comprising filling the containers based on product and container allocation in the container fill table.

19. The method of claim 14, wherein the product is at least one mail piece.

20. A method comprising:
retrieving thickness data and count data on pieces to be placed in containers;
computing a number of containers required for the pieces based on an average of minimum and maximum fill capacities based on fill depth and fill count of the containers;
calculating a final container count by taking an average of the computing step.

21. The method of claim 20, further comprising computing the number of pieces in each container based on final container count and total piece count.

22. The method of claim 21, further comprising:
testing that specific pieces going in each container does not overfill a maximum capacity of the container based on volume; and
if so, adjusting the specific piece count.

23. A system comprising:
means for assigning variables associated with at least one container and a number of drop points;
means for determining at least one threshold value based on the variables; and
means for distributing the product within the at least one container for each drop point based on the determined at least one threshold value.

24. A machine readable medium containing code for filling containers with product, comprising: ;
a module for assigning variables associated with at least one container and a number of drop points;
a module for determining at least one threshold value based on the variables; and
a module for distributing the product within the at least one container for each drop point based on the determined at least one threshold value.
